(19) United States
(12) Patent Application Publication
(10) Pub. No.: US 2010/0008645 A1
(43) Pub. Date: Jan. 14, 2010

(54) INFORMATION RECORDING AND REPRODUCING DEVICE AND METHOD, INFORMATION RECORDING AND REPRODUCING SYSTEM, AND COMPUTER PROGRAM

(75) Inventors: Keiji Katata, Tokorozawa-shi (JP); Takeshi Koda, Tokorozawa-shi (JP); Masayoshi Yoshida, Tokorozawa-shi (JP)

Correspondence Address: YOUNG & THOMPSON, 209 Madison Street, Suite 500, Alexandria, VA, 22314, US

(73) Assignee: PIONEER CORPORATION, TOKYO (JP)

(21) Appl. No.: 12/438,851

(22) PCT Filed: Aug. 29, 2006
(86) PCT No.: PCT/JP2006/316977

§ 371 Date: Mar. 19, 2009

(51) Int. Cl. H04N 5/91

(52) U.S. Cl. 386/83; 386/E05.042

(57) ABSTRACT

An information recording/reproducing apparatus (100) is provided with: a recording device (106) for recording content data and sub data onto an information recording medium (109); a first displaying device (107) for displaying a menu screen which displays a list of the content data; and a second displaying device (107) for displaying a list of the sub data on the menu screen together with the list of the content data.

### TECHNICAL FIELD

The present invention relates to an information recording/reproducing apparatus and method such as a DVD player, a BD player, a HD DVD player, and a HDD recorder, and a computer program which makes a computer function as such an information recording/reproducing apparatus.

### BACKGROUND ART

High-capacity HDD (hard disk drive) recorders or the like have become popular. Along with this, the following television watching has appeared as a new aspect: a television program or the like is timer-recorded and the recorded television program is watched.

### DISCLOSURE OF INVENTION

### Subject to be Solved by the Invention

In the television watching in the new aspect as described above, in most cases, users select and watch only the scenes that the users desire at users' convenient time. In particular, CMs (commercial messages) included in most TV programs are increasingly not watched by being skipped.

However, for advertising companies and advertisers that provide CMs (e.g. electric appliance manufacturers, automakers, and the like), a watching aspect of users not watching CMs by skipping CMs is far from preferable. Moreover, even for users, CMs attached to television programs are information sources from which information about new products or the like can be easily obtained with beautiful motion pictures. Thus, the watching aspect of skipping CMs is far from preferable in consideration of the fact that the watching aspect deprives users of the opportunities of easily obtaining the information about new products with beautiful motion pictures.

In view of the aforementioned problems, it is therefore an object of the present invention to provide an information recording/reproducing apparatus and method, and an information recording/reproducing system, which allow users to watch users' desired advertisements, and a computer program which makes a computer function as such an information recording/reproducing apparatus.

### Means for Solving the Subject

The above object of the present invention can be achieved by an information recording/reproducing apparatus according to claim 1 provided with: a recording device for recording content data and sub data, which is transmitted in parallel with the content data, onto an information recording medium; a first displaying device for displaying a menu screen which displays a list of at least one portion of the content data recorded by the recording device; and a second displaying device for displaying a list of at least one portion of the sub data recorded by the recording device, on the menu screen together with the list of at least one portion of the content data.

The above object of the present invention can be also achieved by an information recording/reproducing method according to claim 15 provided with: a recording process of recording content data and sub data, which is transmitted in parallel with the content data, onto an information recording medium; a first displaying process of displaying a menu screen which displays a list of at least one portion of the content data recorded in the recording process; and a second displaying process of displaying a list of at least one portion of the sub data recorded in the recording process, on the menu screen together with the list of at least one portion of the content data.

The above object of the present invention can be also achieved by an information recording/reproducing system according to claim 16 provided with: an information recording/reproducing apparatus; and a collecting server, the information recording/reproducing apparatus provided with: (i) a recording device for recording content data and sub data, which is transmitted in parallel with the content data, onto an information recording medium; (ii) a first displaying device for displaying a menu screen which displays a list of at least one portion of the content data recorded by the recording device; (iii) a second displaying device for displaying a list of at least one portion of the sub data recorded by the recording device, on the menu screen together with the list of at least one portion of the content data; (iv) a generating device for generating history information which includes at least one of a recording history in which the sub data is recorded, a display history in which the list of at least one portion of the sub data is displayed, and a reproduction history in which the at least one portion of the sub data is reproduced; and (v) a transmitting device for transmitting the history information generated by the generating device, the collecting server provided with: (i) an obtaining device for obtaining the history information transmitted by the transmitting device; and (ii) an analyzing device for analyzing the history information obtained by the obtaining device.

The above object of the present invention can be also achieved by a computer program according to claim 17 for recording/reproduction control and for controlling a computer provided in an information recording/reproducing apparatus provided with: a recording device for recording content data and sub data, which is transmitted in parallel with the content data, onto an information recording medium; a first displaying device for displaying a menu screen which displays a list of at least one portion of the content data recorded by the recording device; and a second displaying device for displaying a list of at least one portion of the sub data recorded by the recording device, on the menu screen together with the list of at least one portion of the content data, the computer program making the computer function as at least one portion of the recording device, the first displaying device, and the second displaying device.

These operation and other advantages of the present invention will become more apparent from the embodiments explained below.

### BRIEF DESCRIPTION OF DRAWINGS

FIG. 1 is a block diagram conceptually showing the basic structure of an information recording/reproducing system in an example.

FIG. 2 is a block diagram conceptually showing the basic structure of a hard disk recorder provided for the information recording/reproducing system in the example.

FIG. 3 is a block diagram conceptually showing the basic structure of a CM history collecting server provided for the information recording/reproducing system in the example.

FIG. 4 is a flowchart conceptually showing a flow of operations of the hard disk recorder in the information recording/reproducing system in the example.

FIG. 5 are data structure diagrams conceptually showing the detailed data structure of each of program data and CM data recorded on a hard disk.

FIG. 6 is a plan view conceptually showing a menu screen displayed by the hard disk recorder in the example.

FIG. 7 is a plan view conceptually showing an image displayed if transition prompting data is selected and activated on the menu screen.

FIG. 8 is a data structure diagram conceptually showing the data structure of CM history data.

FIG. 9 is a timing chart showing a concept when one example of a reproduction history is generated.

FIG. 10 is a flowchart conceptually showing a flow of operations of the CM history collecting server in the information recording/reproducing system in the example.

### DESCRIPTION OF REFERENCE CODES

1 information recording/reproducing system
100 hard disk recorder
101 broadcast antenna
102 tuner device
103 network communication device
105 display speaker
106 recording device
107 menu display device
108 reproduction device
109 hard disk
109a program data area
109b CM data area
109c CM history data area
109d transmission prompting data area
112 CPU
112a CM history data generation device
113 memory
114 operation device
119 data bus
200 CM history collecting server
203 network communication device
207 recording device
209 hard disk
209c CM history data area
209e CM history analysis data area
212 CPU
212a CM history data analysis device
213 memory
214 operation device
219 data bus
300 communication network
400 broadcast station
410 airwave

### BEST MODE FOR CARRYING OUT THE INVENTION

Hereinafter, as the best mode for carrying out the present invention, an explanation will be given on embodiments of the information recording/reproducing apparatus and method, the information recording/reproducing system, and the computer program of the present invention.

### Embodiment of Information Recording/Reproducing Apparatus

An embodiment of the information recording/reproducing apparatus of the present invention is an information recording/reproducing apparatus provided with: a recording device for recording content data and sub data, which is transmitted in parallel with the content data, onto an information recording medium; a first displaying device for displaying a menu screen which displays a list of at least one portion of the content data recorded by the recording device; and a second displaying device for displaying a list of at least one portion of the sub data recorded by the recording device, on the menu screen together with the list of at least one portion of the content data.

According to the embodiment of the information recording/reproducing apparatus of the present invention, by the operation of the recording device, for example, the content data transmitted (i.e. broadcasted) from a broadcast station through airwaves is recorded onto the information recording medium. The content data includes various programs such as movie programs, new programs, entertainment programs, and documentary programs. In the embodiment, in parallel with the transmission of the content data, the sub data including advertisement data (or CM data) described later or the like is also transmitted from the broadcast station through the airwaves. The sub data is preferably transmitted as data independent of the content data in terms of transmission. The sub data transmitted in parallel with the content data is also recorded onto the information recording medium by the operation of the recording device.

As for the content data recorded on the information recording medium, firstly, the menu screen which displays the list of at least one portion of the content data is displayed by the operation of the first displaying device. For example, if the content data includes one movie program, two news programs, three entertainment programs, and four documentary programs, the menu screen is displayed which shows a list of one portion of the programs (e.g. the one movie program, the two news programs, and two of the four documentary programs) using, for example, the thumbnail images or the like of the programs. After that, at least one portion of the content data selected from the list displayed on the menu screen (e.g. the one movie program, one news program, or the like) is actually reproduced.

In the embodiment, in particular, by the operation of the second displaying device, the list of at least one portion of the sub data, which is transmitted in parallel with the content data and which is recorded on the information recording medium, is displayed on the menu screen together with the list of at last one portion of the content data displayed as the menu screen by the operation of the first displaying device. That is, by the operation of the second displaying device, the list of at least one portion of the sub data is included on the menu screen, together with the list of at least one portion of the content data.

By this, users can watch the content data if selecting the list of at least one portion of the content data displayed on the menu screen. Meanwhile, the users can watch the sub data if selecting the list of at least one portion of the sub data displayed on the same menu screen. That is, the users can selectively watch the sub data if the users want to watch the sub data including the advertisement data or the like. On the other hand, the users can selectively watch the content data without watching the sub data if the users do not want to watch the sub data including the advertisement data or the like.

In addition, the list of at least one portion of the content data and the list of at least one portion of the sub data are menu-displayed on the same menu screen. Thus, even the sub data can be selected and watched in the same aspect as the content data.

As described above, according to the embodiment, from among the content data and the sub data, users can select and watch the data that the users desire. This can preferably prevent such a disadvantage that the sub data is not displayed or that the sub data is not displayed despite users' intentions. Then, it is possible to allow the users to certainly watch the sub data that the users desire.

In one aspect of the embodiment of the information recording/reproducing apparatus of the present invention, the second displaying device displays the list of at least one portion of the sub data on the menu screen in substantially a same aspect as the list of at least one portion of the content data.

According to this aspect, the list of at least one portion of the content data and the list of at least one portion of the sub data are displayed on the menu screen in substantially the same aspect (e.g. in such an aspect that users can regard the lists as a single menu screen without uncomfortable feelings). Thus, even the sub data can be selected and watched in the same aspect as the content data.

In another aspect of the embodiment of the information recording/reproducing apparatus of the present invention, the second displaying device displays, on the menu screen, the list of at least one portion of the sub data related to the at least one portion of the content data displayed on the menu screen.

According to this aspect, it is possible to display the list of at least one portion of the content data and the list of at least one portion of the sub data related to the at least one portion of the content data (e.g. their fields are related or the same, or their watching targets are related or the same), on the menu screen. This can prompt users who are interested in at least one portion of the content data, to watch the sub data that is more attractive.

In another aspect of the embodiment of the information recording/reproducing apparatus of the present invention, the recording device records related data, which indicates a relation between the content data and the sub data transmitted in parallel with the content data, onto the information recording medium.

According to this aspect, it is possible to display, on the menu screen, the list of at least one portion of the sub data related to the at least one portion of the content data displayed on the menu screen, relatively easily, on the basis of the related data.

In another aspect of the embodiment of the information recording/reproducing apparatus of the present invention, the sub data includes banner data which indicates one or a plurality of banner images used when the list of the sub data is displayed on the menu screen, and the second displaying device displays the list of at least one portion of the sub data by displaying the desired banner image of the one or the plurality of banner images.

According to this aspect, using the banner data included in the sub data, the list of at least one portion of the sub data can be preferably displayed on the menu screen.

In an aspect of the information recording/reproducing apparatus in which the sub data includes the banner data, as described above, the displaying device may select the desired banner image of the one or the plurality of banner images in accordance with at least one of resolution of the content data whose list is displayed on the menu screen, a position at which the banner image is displayed, and a display aspect of the menu screen, and the displaying device displays the list of at least one portion of the sub data by displaying the selected desired banner image.

According to this aspect, while the optimum or preferable banner image is selected at each time that the menu screen is displayed, the list of at least one portion of the sub data can be preferably displayed on the menu screen.

In another aspect of the embodiment of the information recording/reproducing apparatus of the present invention, the sub data includes advertisement data related to the content data transmitted in parallel with the sub data.

According to this aspect, it is possible to allow users to watch the advertisement data that the users desire.

In another aspect of the embodiment of the information recording/reproducing apparatus of the present invention, the information recording medium comprises a recording area in which the content data is recorded, and a recording area in which the sub data is recorded.

According to this aspect, the content data and the sub data can be physically or logically separated and recorded onto the information recording medium. Thus, it is possible to receive the benefit that even the recording of the sub data does not have an adverse effect on the recording of the content data.

In another aspect of the embodiment of the information recording/reproducing apparatus of the present invention, the information recording medium has the sub data recorded in advance.

According to this aspect, manufacturers of the information recording/reproducing apparatus can ship the information recording/reproducing apparatus in the status that the sub data the manufacturer want users to watch is recorded on the information recording medium in advance.

In another aspect of the embodiment of the information recording/reproducing apparatus of the present invention, it is further provided with a generating device for generating history information which includes at least one of a recording history (e.g. the number of times of the recording or the like) in which the sub data is recorded, a display history (e.g. the number of times of the display or the like) in which the list of at least one portion of the sub data is displayed, and a reproduction history (e.g. the number of times of the reproduction or the like) in which the at least one portion of the sub data is reproduced.

According to this aspect, it is possible to analyze the degree of users' interests in the sub data on the basis of the history information generated by the operation of the generating device. Therefore, the sub data which further attracts users' interests can be transmitted in parallel with the content data. Moreover, the sub data which further attracts users' interests can be transmitted in parallel with the content data related to the sub data.

In an aspect of the information recording/reproducing apparatus provided with the generating device as described above, the generating device may generate the history information which includes the reproduction history including a history which indicates how long the at least one portion of the sub data is reproduced.

By virtue of such construction, it is possible to analyze the degree of users' interests in the sub data on the basis of the history information generated by the generating device. Therefore, the sub data which further attracts users' interests can be transmitted in parallel with the content data. Moreover, the sub data which further attracts users' interests can be transmitted in parallel with the content data related to the sub data.

In an aspect of the information recording/reproducing apparatus provided with the generating device as described above, it may be further provided with a transmitting device for transmitting the history information generated by the generating device, to a collecting server for collecting the history information.

By virtue of such construction, it is possible to analyze the degree of users' interests in the sub data on the basis of the history information generated by the generating device, by the operation of the collecting server to which the history information is transmitted. Therefore, the sub data which further attracts users' interests can be transmitted in parallel with the content data. Moreover, the sub data which further attracts users' interests can be transmitted in parallel with the content data related to the sub data.

In an aspect of the information recording/reproducing apparatus provided with the transmitting device as described above, prompting data which indicates a display screen for prompting a user to transmit the history information to the collecting server may be recorded onto the information recording medium.

By virtue of such construction, the history information is transmitted to the collecting server, more easily. In addition, the history information can be transmitted to the collecting server in consideration of users' intentions. That is, the history information can be transmitted to the collecting server, aimed at users who allow the transmission of the history information after watching the display screen indicated by the prompting data.

In an aspect of the information recording/reproducing apparatus in which the prompting data is recorded onto the information recording medium as described above, the second displaying device may display a list of the prompting data on the menu screen, in preference to the list of at least one portion of the sub data recorded by the recording device.

By virtue of such construction, the history information is transmitted to the collecting server, more easily. That is, it is possible to more strongly prompt users to transmit the history information to the collecting server.

### Embodiment of Information Recording/Reproducing Method

An embodiment of the information recording/reproducing method of the present invention is an information recording/reproducing method provided with: a recording process of recording content data and sub data, which is transmitted in parallel with the content data, onto an information recording medium; a first displaying process of displaying a menu screen which displays a list of at least one portion of the content data recorded in the recording process; and a second displaying process of displaying a list of at least one portion of the sub data recorded in the recording process, on the menu screen together with the list of at least one portion of the content data.

According to the embodiment of the information recording/reproducing method of the present invention, it is possible to receive the same various benefits as those of the aforementioned embodiment of the information recording/reproducing apparatus of the present invention.

Incidentally, in response to the various aspects in the embodiment of the information recording/reproducing apparatus of the present invention, the embodiment of the information recording/reproducing method of the present invention can also employ various aspects.

### Embodiment of Information Recording/Reproducing System

An embodiment of the information recording/reproducing system of the present invention is an information recording/reproducing system provided with: an information recording/reproducing apparatus; and a collecting server, the information recording/reproducing apparatus provided with: (i) a recording device for recording content data and sub data, which is transmitted in parallel with the content data, onto an information recording medium; (ii) a first displaying device for displaying a menu screen which displays a list of at least one portion of the content data recorded by the recording device; (iii) a second displaying device for displaying a list of at least one portion of the sub data recorded by the recording device, on the menu screen together with the list of at least one portion of the content data; (iv) a generating device for generating history information which includes at least one of a recording history in which the sub data is recorded, a display history in which the list of at least one portion of the sub data is displayed, and a reproduction history in which the at least one portion of the sub data is reproduced; and (v) a transmitting device for transmitting the history information generated by the generating device, the collecting server provided with: (i) an obtaining device for obtaining the history information transmitted by the transmitting device; and (ii) an analyzing device for analyzing the history information obtained by the obtaining device.

According to the embodiment of the information recording/reproducing system of the present invention, the information recording/reproducing apparatus displays the menu screen and generates the history information, as described above. Then, the history information is transmitted to the collecting server.

In the collecting server, the history information is obtained by the operation of the obtaining device, and then the history information is analyzed by the operation of the analyzing device. For example, the analyzing device scores each sub data in accordance with the history information.

This allows users to select and watch the data that the users desire and allows the analysis of the degree of the users' interests in the sub data. That is, according to the information recording/reproducing system ion the embodiment, it is possible to receive the same various benefits as those of the aforementioned information recording/reproducing apparatus in the embodiment.

Incidentally, in response to the various aspects in the embodiment of the information recording/reproducing apparatus of the present invention, the embodiment of the information recording/reproducing system of the present invention can also employ various aspects.

### Embodiment of Computer Program

An embodiment of the computer program of the present invention is a computer program for recording/reproduction control and for controlling a computer provided in an information recording/reproducing apparatus provided with: a recording device for recording content data and sub data, which is transmitted in parallel with the content data, onto an information recording medium; a first displaying device for displaying a menu screen which displays a list of at least one portion of the content data recorded by the recording device; and a second displaying device for displaying a list of at least one portion of the sub data recorded by the recording device, on the menu screen together with the list of at least one portion of the content data (i.e. the aforementioned embodiment of the information recording/reproducing apparatus of the present invention (including its various aspects)), the computer program making the computer function as at least one portion of the recording device, the first displaying device, and the second displaying device.

According to the computer program of the present invention, the aforementioned embodiment of the information recording/reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects in the aforementioned embodiment of the information recording/reproducing apparatus of the present invention, the embodiment of the computer program of the present invention can also employ various aspects.

The above object of the present invention can be also achieved by a computer program product in a computer-readable medium for tangibly embodying a program of instructions executable by a computer provided in an information recording/reproducing apparatus provided with: a recording device for recording content data and sub data, which is transmitted in parallel with the content data, onto an information recording medium; a first displaying device for displaying a menu screen which displays a list of at least one portion of the content data recorded by the recording device; and a second displaying device for displaying a list of at least one portion of the sub data recorded by the recording device, on the menu screen together with the list of at least one portion of the content data (i.e. the aforementioned embodiment of the information recording/reproducing apparatus of the present invention (including its various aspects)), the computer program product making the computer function as at least one portion of the recording device, the first displaying device, and the second displaying device.

According to the embodiment of the computer program product of the present invention, the aforementioned embodiment of the information recording/reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the information recording/reproducing apparatus of the present invention.

Incidentally, in response to the various aspects in the aforementioned embodiment of the information recording/reproducing apparatus of the present invention, the embodiment of the computer program product of the present invention can also employ various aspects.

These operation and other advantages of the embodiments will become more apparent from the example explained below.

As explained above, according to the embodiment of the information recording/reproducing apparatus of the present invention, it is provided with the recording device, the first displaying device, and the second displaying device. According to the embodiment of the information recording/reproducing method of the present invention, it is provided with the recording process, the first displaying process, and the second displaying process. According to the embodiment of the computer program of the present invention, it makes the computer function as the recording device, the first displaying device, and the second displaying device. Therefore, it is possible to allow users to watch the desired advertisements that the users desire.

### Example

Hereinafter, an example of the present invention will be explained with reference to the drawings.

### (1) Basic Structure

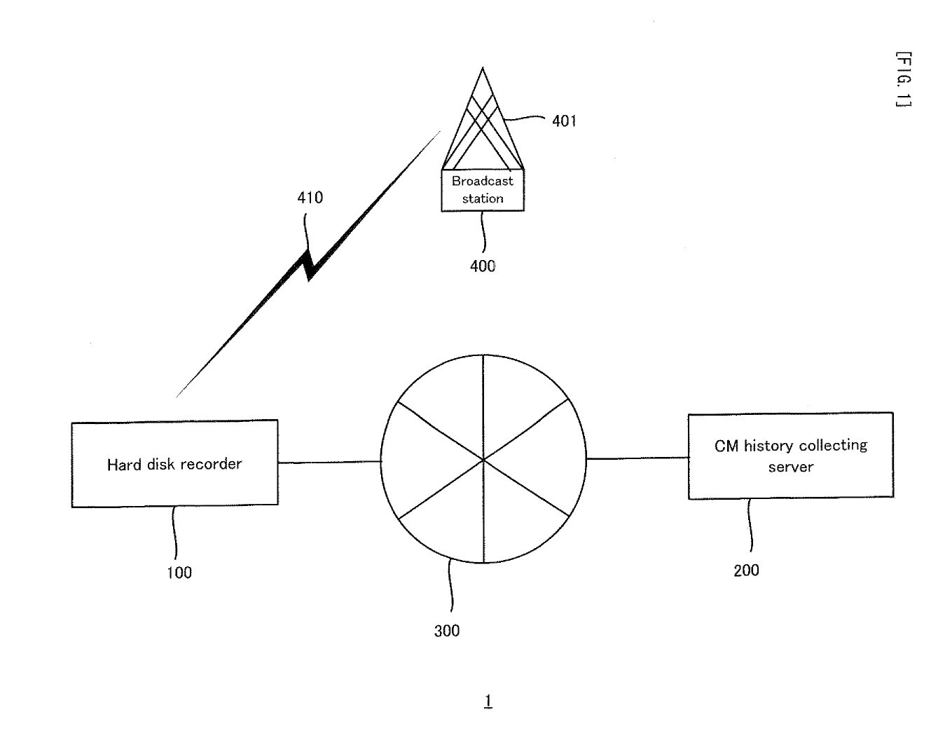

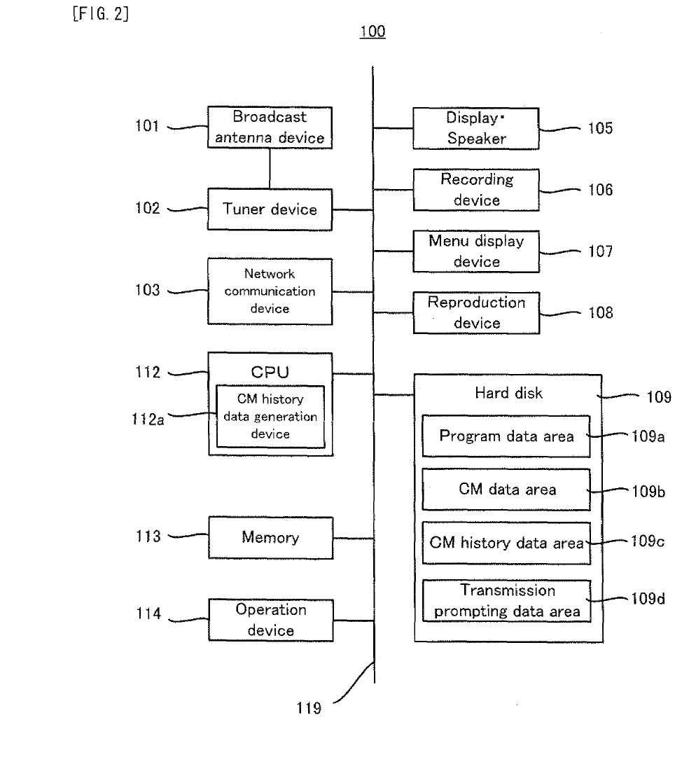

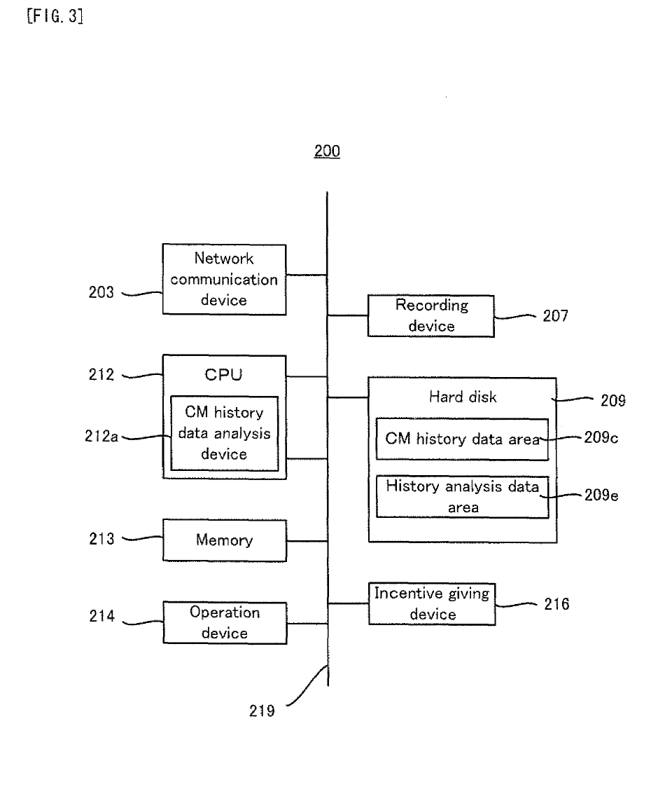

Firstly, with reference to FIG. 1 to FIG. 3, an explanation will be given on the basic structure of an information recording/reproducing system 1 as an example of the information recording/reproducing system of the present invention. FIG. 1 is a block diagram conceptually showing the basic structure of the information recording/reproducing system 1 in the example. FIG. 2 is a block diagram conceptually showing the basic structure of a hard disk recorder 100 provided for the information recording/reproducing system 1 in the example. FIG. 3 is a block diagram conceptually showing the basic structure of a CM history collecting server 200 provided for the information recording/reproducing system 1 in the example.

As shown in FIG. 1, the information recording/reproducing system 1 is provided with a hard disk recorder 100, a CM history collecting server 200, a communication network 300, and a broadcast station 400.

The hard disk recorder 100 constitutes one specific example of the “information recording/reproducing apparatus” of the present invention. The hard disk recorder 100 is provided with a function of receiving an airwave 410 broadcasted from the broadcast station 400 and a function of recording (in other words, video-recording) a television program obtained by demodulating the airwave 410 onto an information recording medium such as a hard disk. Moreover, the hard disk recorder 100 is provided with a function of making a wireless or wired communication with the CM history collecting server 200 through the communication network 300. The specific structure of the hard disk recorder 100 will be detailed later (refer to FIG. 2).

The CM history collecting server 200 constitutes one specific example of the “collecting server” of the present invention. The CM history collecting server 200 obtains CM history data transmitted from the hard disk recorder 100 through the communication network 300 and analyzes the CM history data. The specific structure of the CM history collecting server 200 will be detailed later (refer to FIG. 3).

The communication network 300 includes, for example, a wireless network or a wired network such as a fixed-line phone network, a packet communication network, the Internet, a mobile phone network, IMT-2000, a PHS, and a wireless LAN. Incidentally, the entire communication line between the car navigation apparatus 100 and the hard disk recorder is not necessarily the wired or wireless network; one portion of the communication line may be the wired or wireless network.

The broadcast station 400 is a base station for broadcasting television programs and is provided with a transmission antenna 401. From the transmission antenna 401, the airwave 410 is transmitted. By virtue of the airwave 410, program data is broadcasted which indicates the television programs such as movie programs, news programs, entertainment programs, and documentary programs.

In the example, moreover, by virtue of the airwave 410, CM data which indicates advertisement information and announcement information (hereinafter referred to as “CM” as occasion demands) is broadcasted as data independent of content data. For example, if the broadcast station 400 and the airwave 410 comply with terrestrial digital broadcasting, the CM data is broadcasted using the segment that is not used for the content data broadcast of 13 segments included in the airwave 410. Alternatively, the CM data may be broadcasted as character data broadcasting in the content data.

Incidentally, FIG. 1 explains the information recording/reproducing system 1 provided with one hard disk recorder 100; however, it is obvious that the information recording/reproducing system 1 may be provided with two or more hard disk recorders 100. In the same manner, it is obvious that the information recording/reproducing system 1 may be provided with two or more CM history collecting servers 200.

As shown in FIG. 2, the hard disk recorder 100 is provided with a broadcast antenna 101, a tuner device 102, a network communication device 103, a display speaker 105, a recording device 106, a menu display device 107, a reproduction device 108, a hard disk 109, a CPU 112, a memory 113, an operation device 114, and a data bus 119.

The broadcast antenna 101 receives the airwave 410 transmitted from the broadcast station 400 as a broadcast signal and outputs the received broadcast signal to the tuner device 102.

The tuner device 102 performs a tuning process on the broadcast signal received on the broadcast antenna 101. By virtue of the tuning process, broadcast signals in a frequency band according to the channels of the television program and CM that a user desires are outputted to the recording device 107 as the program data and the CM data.

The network communication device 103 constitutes one specific example of the “transmitting device” of the present invention. The network communication device 103 transmits the data to and receives the data from the CM history collecting server 200 through the communication network 300. Specifically, the network communication device 103 transmits the CM history data generated by a CM history data generation device 112a described later, to the CM history collecting server 200. At this time, the network communication device 103 converts the CM history data to be transmitted, into a communication format according to the communication network 300.

The display speaker 105 is adapted to output the program data and the CM data reproduced by the operation of the reproduction device 108 and a menu screen displayed by the operation of the menu display device 107, as actual video and audio.

The recording device 106 constitutes one specific example of the “recording device” of the present invention. The recording device 106 records the program data and the CM data received on the tuner device 102 onto the hard disk 109.

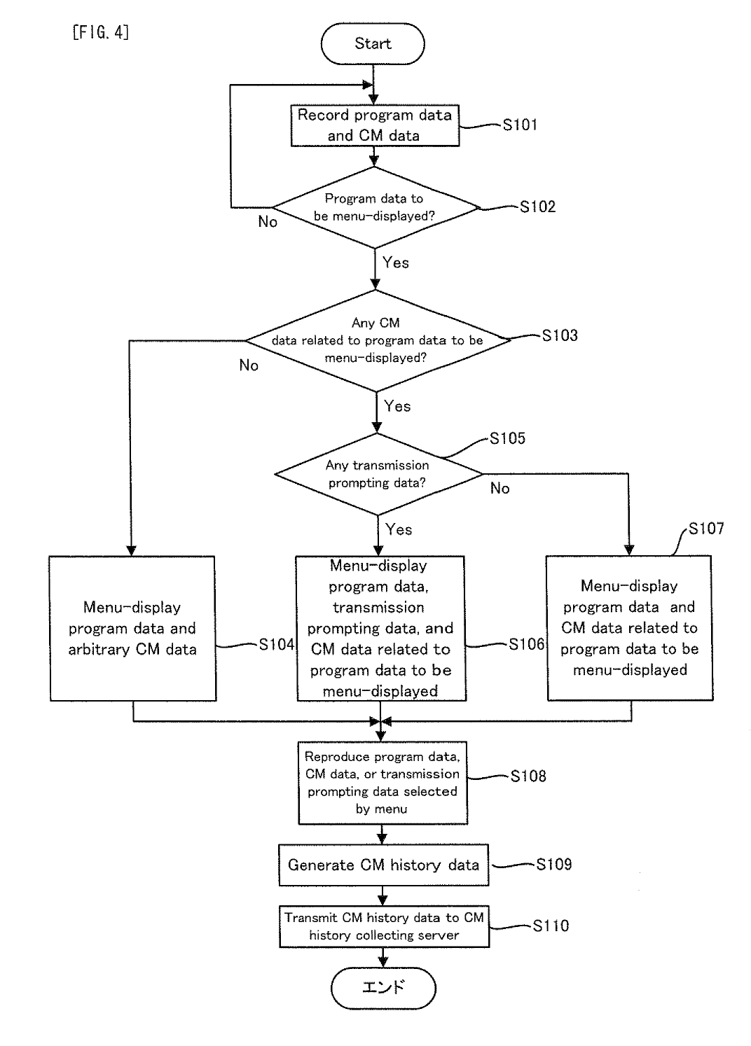

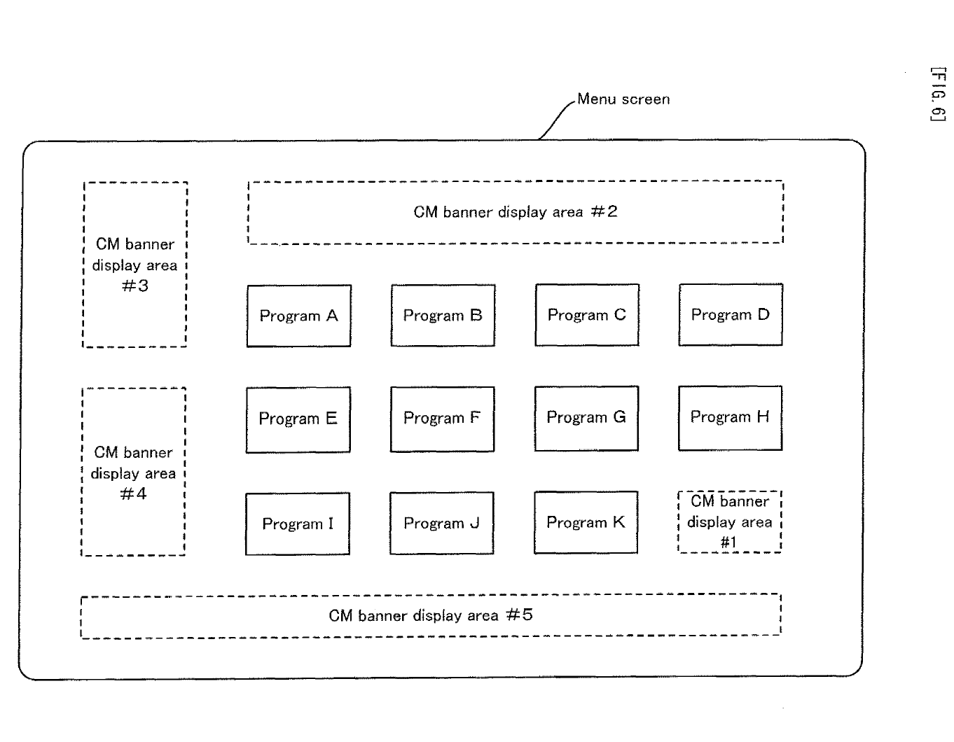

The menu display device 107 constitutes one specific example of the “first displaying device” and the “second displaying device” of the present invention. The menu display device 107 menu-displays at least one portion of the program data and the CM data recorded on the hard disk 109. That is, the menu display device 107 displays the menu screen which indicates a list of at least one portion of the program data and the CM data recorded on the hard disk 109. The operation of the menu display device 107 and the menu screen will be detailed later (refer to FIG. 4 and FIG. 6).

The reproduction device 108 reproduces the program data and the CM data recorded on the hard disk 109. In this case, the reproduction device 108 reproduces the program data or the CM data selected by the user on the menu screen displayed by the operation of the menu display device 107.

The hard disk 109 constitutes one specific example of the “information recording medium” of the present invention. The hard disk 109 is a magnetic recording medium and stores map data 110 such that it can be held for a long term. Incidentally, it is obvious that not only the hard disk 109 but also an optical disc such as a CD and a DVD and other various recording media may be used.

In the example, in particular, the recording area in the hard disk 109 is divided into a program data area 109a, which is a recording area in which the program data is recorded; a CM data area 109b, which is a recording area in which the CM data is recorded; a CM history data area 109c, which is a recording area in which the CM history data is recorded; and a transmission prompting data area 109d, which is a recording area in which transmission prompting data is recorded.

The CM history data is generated by the operation of a CM history data generation device 112a. The CM history data includes recording history data, which indicates the number of times of recording the CM data onto the hard disk 109 or the like; display history data, which indicates Ihe number of times of menu-displaying the CM data by the menu display device 107 or the like; and reproduction history data, which indicates the number of times of reproducing the CM data by the reproduction device 108 or the like.

The transmission prompting data is data for displaying an allowance screen for having the user allowed or for promoting the user to transmit the CM history data from the hard disk recorder 100 to the CM history collecting server 200. The transmission prompting data may be recorded in advance (e.g. in manufacturing or shipping the hard disk recorder 100) in the transmission prompting data area 109d in the hard disk 109. Alternatively, if the transmission prompting data is broadcasted by the airwave 410, the transmission prompting data received on the broadcast antenna device 101 may be recorded into the transmission prompting data area 109d in the hard disk 109 by the operation of the recording device 106.

Moreover, in the CM data area 109b in the hard disk 109, the CM data may be recorded in advance (e.g. in manufacturing or shipping the hard disk recorder 100). In the same manner, in the program data area 109a in the hard disk 109, the program data may be recorded in advance (e.g. in manufacturing or shipping the hard disk recorder 100).

The CPU 112 is connected to the tuner device 102, the network communication device 103, the display speaker 105, the recording device 106, the menu display device 107, the reproduction device 108, the hard disk 109, the operation device 114, and the memory 113 through the data bus 119. The CPU 112 gives instructions to those constituent devices, to thereby control the entire hard disk recorder 100. In general, software or firmware for operating the CPU 112 is stored in the memory 113.

In the example, in particular, the CPU 112 is provided with a CM history data generation device 112a, which constitutes one specific example of the “generating device” of the present invention. The CM history data generation device 112a generates the CM history data. The generated CM history data is recorded into the CM history data area 109c in the hard disk 109 and is transmitted to the CM history collecting server 200 by the operation of the network communication device 103.

The memory 113 includes a ROM area in which a program for performing operations as the hard disk recorder 100, i.e. firmware, is stored; and a ROM area for temporarily storing various data used when the operations as the hard disk recorder 100 are performed.

The operation device 114 is provided with, for example, a remote controller, a touch panel, an operation button, a mouse, a keyboard, and the like. The operation device 114 outputs user operation information related to the user's operations using the operation device 114.

As shown in FIG. 3, the CM history collecting server 200 is provided with a network communication device 203, a recording device 207, a hard disk 209, a CPU 212, a memory 213, an operation device 214, and a data bus 219.

The network communication device 203 constitutes one specific example of the “obtaining device” of the present invention. The network communication device 203 transmits the data to and receives the data from the hard disk recorder 100 through the communication network 300. Specifically, the network communication device 203 receives the CM history data transmitted from the hard disk recorder 100. At this time, the network communication device 203 converts the data to be received, into a format for data-processing in the CM history collecting server 200.

The recording device 207 records the CM history data received on the network communication device 203 and history analysis data generated by a CM history analysis device 212a described later onto the hard disk 209.

The hard disk 209 is a magnetic recording medium and stores the content data recorded by the operation of the recording device 207 such that it can be held for a long term. Incidentally, it is obvious that not only the hard disk 209 but also an optical disc such as a CD and a DVD and other various recording media may be used.

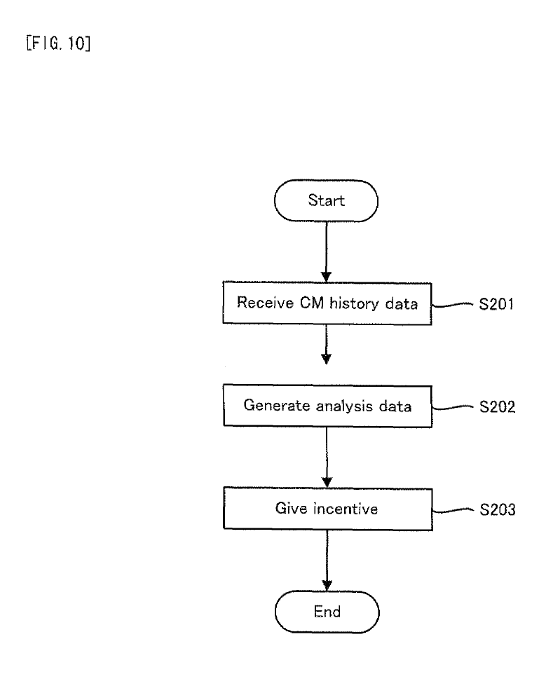

In the example, in particular, the recording area in the hard disk 209 is divided into a CM history data area 209c, which is a recording area in which the CM history data is recorded; and a CM history analysis data area 209e, which is a recording area in which the CM history analysis data generated by the CM history analysis device 212a described later is recorded. Incidentally, the CM history analysis data will be detailed later (refer to FIG. 10).

The CPU 212 is connected to the network communication device 203, the recording device 207, the hard disk 209, the operation device 214, and the memory 213 through the data bus 219. The CPU 112 gives instructions to those constituent devices, to thereby control the entire hard disk recorder 200. In general, software or firmware for operating the CPU 212 is stored in the memory 213.

In the example, in particular, the CPU 212 is provided with a CM history data analysis device 212a, which constitutes one specific example of the “analyzing device” of the present invention. The CM history data analysis device 212a analyzes the CM history data transmitted from the hard disk recorder 100. Incidentally, the operation of the CM history data analysis device 212a will be detailed later (refer to FIG. 10).

The memory 213 includes a ROM area in which a program for performing operations as the CM history collecting server 200, i.e. firmware, is stored; and a ROM area for temporarily storing various data used when the operations as the CM history collecting server 200 are performed.

The operation device 214 is provided with, for example, a remote controller, a touch panel, an operation button, a mouse, a keyboard, and the like. The operation device 214 outputs user operation information related to the user's operations using the operation device 214.

### (2) Operation Example

Next, with reference to FIG. 4 to FIG. 10, an explanation will be given on an operation example of the information recording/reproducing system 1 in the example.

### (2-2) Operation Example of Hard Disk Recorder

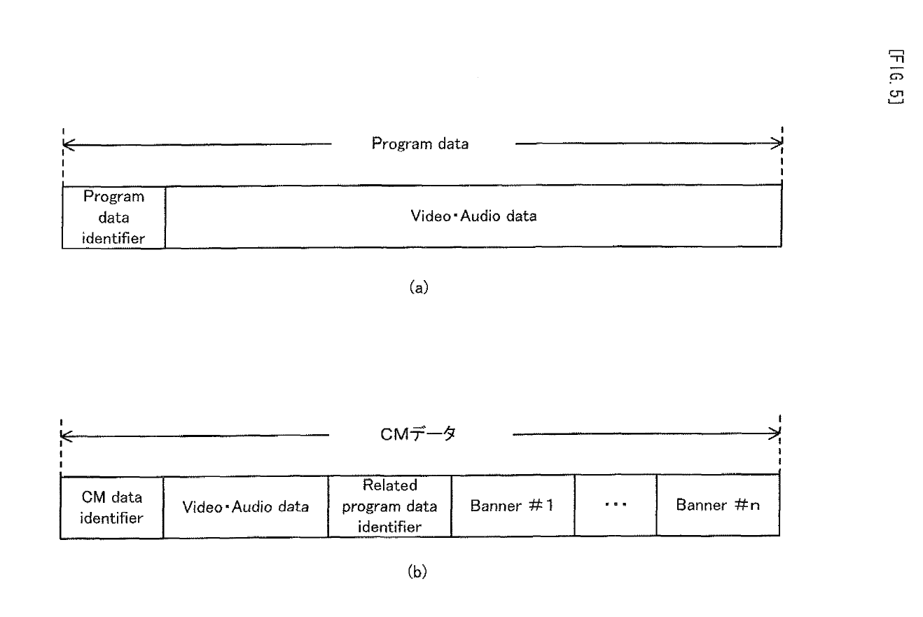

Firstly, with reference to FIG. 4 to FIG. 9, an explanation will be given on an operation example of the hard disk recorder 100 of the information recording/reproducing system 1 in the example. Here, the entire operation example of the hard disk recorder 100 is explained with reference to FIG. 4, and a more detailed explanation is given with reference to FIG. 5 to FIG. 9 as occasion demands. FIG. 4 is a flowchart conceptually showing a flow of operations of the hard disk recorder 100 in the information recording/reproducing system 1 in the example.

As shown in FIG. 4, firstly, each of the program data and the CM data received by the operation of the tuner device 102 is recorded onto the hard disk 109 by the operation of the recording device 106 (step S101). Incidentally, the user may give an instruction to start the recording in real time with the operation device 104, or a timer or the like for specifying a recording start time point may be set.

Now, with reference to FIG. 5, an explanation is given on the detailed data structure of each of the program data and the CM data recorded on the hard disk 109. FIG. 5 are data structure diagrams conceptually showing the detailed data structure of each of the program data and the CM data recorded on the hard disk 109.

As shown in FIG. 5(a), the program data includes a program data identifier, which indicates a unique ID number or the like to identify the program data; and video and audio data, which indicates actual video and audio of the television program.

As shown in FIG. 5(b), the CM data includes a CM data identifier, which indicates a unique ID number or the like to identity the CM data; and video and audio data, which indicates actual video and audio of the CM.

The CM data further includes a related program data identifier, which indicates the identifier of the program data related to the CM data. For example, the related program data includes the identifier of the program data broadcasted in parallel with the CM data at the same time point, the identifier of the program data including the program content in the same field as the CM data, and the like. More specifically, the CM data broadcasted in parallel with program data #1 broadcasted from 7:00 pm to 7:30 pm includes the related program data which indicates the identifier of the program data #1. Alternatively if there is program data #2 including the program content about motor sports, the CM data including the CM of automakers includes the related program data which indicates the identifier of the program data #2.

The CM data further includes n banner images #1 to #n (wherein n is an integer of 1 or more), which are used when the CM data is menu-displayed. In the n banner images #1 to #n, the optimum or preferable banner image is selected and displayed when being actually menu-displayed, in accordance with the resolution of the program data to be menu-displayed (e.g. whether the program data are HD (High Definition) images or SD (Standard Definition images)), a position at which a list of the CM data is displayed on the menu screen, and a display aspect of the menu screen.

Incidentally, the program data and the CM data may have the data structure shown in FIG. 5 when being broadcasted from the broadcast station 400. Alternatively, even if not having the data structure shown in FIG. 5 when being broadcasted from the broadcast station 400, the program data and the CM data may have the data structure shown in FIG. 5 at least when being recorded onto the hard disk 109.

Moreover, the CM data recorded on the hard disk 109 is preferably erased from the hard disk 109 after a certain time (e.g. after several days, a week, several weeks, or several months), in order to ensure the recording capacity of the hard disk 109 (in particular, the recording capacity of the CM data area 109b).

In FIG. 4 again, it is judged whether or not an instruction to menu-display the program data (or one portion thereof recorded on the hard disk 109 is given by the user (step S102).

As a result of the judgment in the step S102, if it is judged that the instruction to menu-display the program data recorded on the hard disk 109 is not given by the user (the step S102: No), the operational flow returns to the step S101 to continue to record the program data and the CM data.

On the other hand, as a result of the judgment in the step S102, if it is judged that the instruction to menu-display the program data recorded on the hard disk 109 is given by the user (the step S102: Yes), then it is judged whether or not the CM data related to the program data to be menu-displayed is recorded in the hard disk 109 (step S103). More specifically, it is judged whether or not the CM data including the program data identifier of the program data to be menu-displayed as the related program data identifier is recorded in the hard disk 109.

As a result of the judgment in the step S103, if it is judged that the CM data related to the program data to be menu-displayed is not recorded in the hard disk 109 (the step S103: No), the program data recorded in the hard disk 109 and arbitrary data of the CM data recorded in the hard disk 109 are menu-displayed (step S104). That is, arbitrary CM data is menu-displayed on the menu display, regardless of the broadcast time, program content, or the like of the program data to be menu-displayed.

On the other hand, as a result of the judgment in the step S103, if it is judged that the CM data related to the program data to be menu-displayed is recorded in the hard disk 109 (the step S103: Yes), then it is judged whether or not the transmission prompting data is recorded in the hard disk 109 (step S105).

As a result of the judgment in the step S105, if it is judged that the transmission prompting data is recorded in the hard disk 109 (the step S105: Yes), the program data recorded in the hard disk 109, the CM data related to the program data to be menu-displayed of the CM data recorded in the hard disk 109, and the transmission prompting data are menu-displayed (step S106). That is, the transmission prompting data is menu-displayed on the menu display together with the CM data related to the broadcast time, program content, or the like of the program data to be menu-displayed.

On the other hand, as a result of the judgment in the step S105, if it is judged that the transmission prompting data is not recorded in the hard disk 109 (the step S105: No), the program data recorded in the hard disk 109 and the CM data related to the program data to be menu-displayed of the CM data recorded in the hard disk 109 are menu-displayed (step S107). That is, the CM data related to the broadcast time, program content, or the like of the program data to be menu-displayed is menu-displayed on the menu display.

That is, the operations in the step S103 to the step S107 are summarized as follows; on the menu screen, the transmission prompting data, the CM data related to the program data to be menu-displayed is menu-displayed in this priority order.

After that, the program data, the CM data, or the transmission prompting data, selected and activated on the menu screen displayed in the step S104, the step S106, or the step S107 is actually reproduced as video and audio by the operation of the reproduction device 108 (step S108).

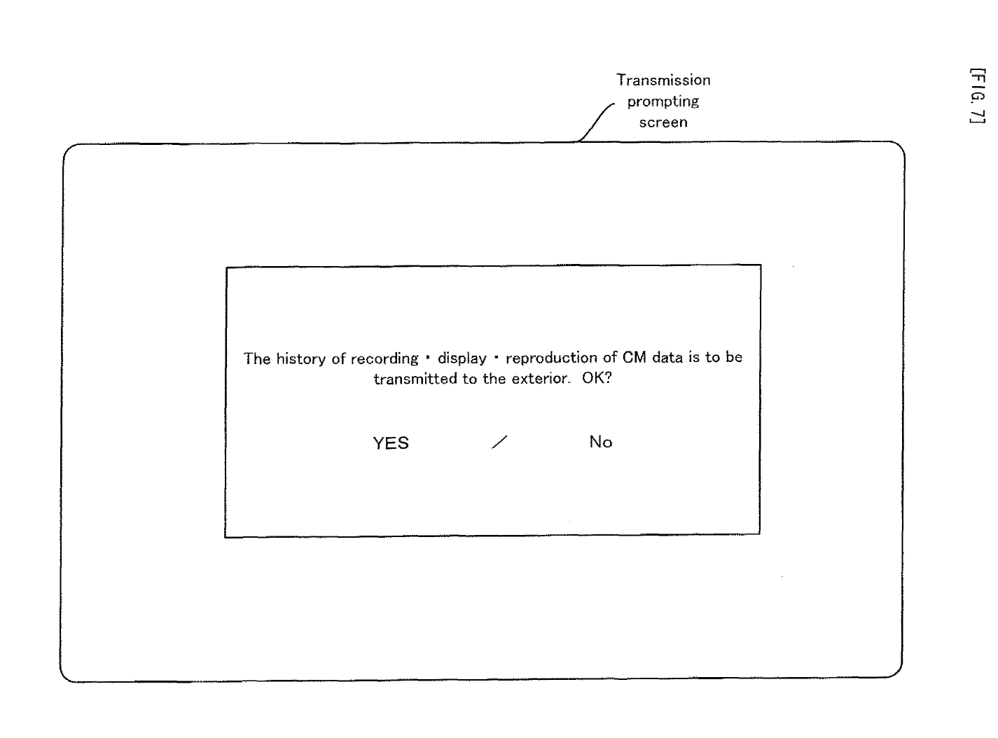

Now, with reference to FIG. 6 and FIG. 7, the details of the menu screen actually displayed will be explained. FIG. 6 is a plan view conceptually showing a menu screen displayed by the hard disk recorder 100 in the example. FIG. 7 is a plan view conceptually showing an image displayed if transition-prompting data is selected and activated on the menu screen.

As shown in FIG. 6, the menu screen displays respective thumbnail images of a program A, a program B, a program C, a program D, a program E, a program F, a program G, a program H, a program I, a program J, and a program K recorded on the hard disk 100. By the user selecting and activating the thumbnail image of the desired program, the reproduction of the desired program can be started. For example, if the thumbnail image of the program G is selected and activated, the program G is reproduced.

Moreover, the menu screen ensures CM banner display areas #1 to #5, which are areas for menu-displaying the CM data and the transmission prompting data recorded on the hard disk 100. The CM data or the transmission prompting data is menu-displayed in any of the CM banner display areas #1 to #5 by that the corresponding banner image is displayed.

In each CM banner display area, the preferable banner image is preferably selected from the n banner images #1 to #n included in the corresponding CM data and the banner image is preferably displayed, for example, by the operation of the CPU 112 in accordance with the resolution of the program data to be menu-displayed (e.g. whether the program data are HD (High Definition) images or SD (Standard Definition images)), the position at which a list of the CM data (i.e. the banner image) is displayed on the menu screen, and the display aspect of the menu screen.

For example, if the banner image corresponding to CM data #1 is displayed in the CM banner display area #1, such a banner image is preferably displayed that matches the size of the CM banner display area #1 and that matches the resolution of the programs A to H. In this case, the CM data #1 is reproduced by selecting and activating the banner image displayed in the CM banner display area #1. Alternatively, if the banner image corresponding to the transmission prompting data is displayed in the CM banner display area #5, the transmission prompting data is reproduced by selecting and activating the banner image displayed in the CM banner display area #5.

If the transmission prompting data is reproduced, for example, a transmission prompting screen as shown in FIG. 7 is displayed. As shown in FIG. 7, the transmission prompting screen inquires of the user about a permission to transmit the CM history data generated by the hard disk recorder 100 (more specifically, the CM history data generation device 112a) to the CM history collecting server. If the user indicates the intension, using the transmission prompting screen, to allow the CM history data to be transmitted to the CM history collecting server, the CM history data is transmitted to the CM history collecting server. On the other hand, if the user does not indicate the intension, using the transmission prompting screen, to allow the CM history data to be transmitted to the CM history collecting server, the CM history data is preferably not transmitted to the CM history collecting server.

Incidentally, the areas in which the banner images of the CM data are displayed shown in FIG. 6 (i.e. the CM banner image display areas #1 to #5) are merely one specific example, and it is obvious that the banner image may be displayed in a position other than this example, or that the banner image with a size other than this example may be displayed.

Moreover, the plurality of CM banner display areas #1 to #5 are shown in FIG. 6; however, the CM data may be menu-displayed using all the display areas or selected one(s) of the display areas.

In FIG. 4 again, then, the CM history data is generated by the operation of the CM history data generation device 112a (step S109), and the generated CM history data is transmitted to the CM history collecting server 200 (step S110). The CM history data may be transmitted to the CM history collecting server 200 at each time that the CM history data is generated, or every certain period (e.g. every day, every a few days, every week, or every a few weeks).

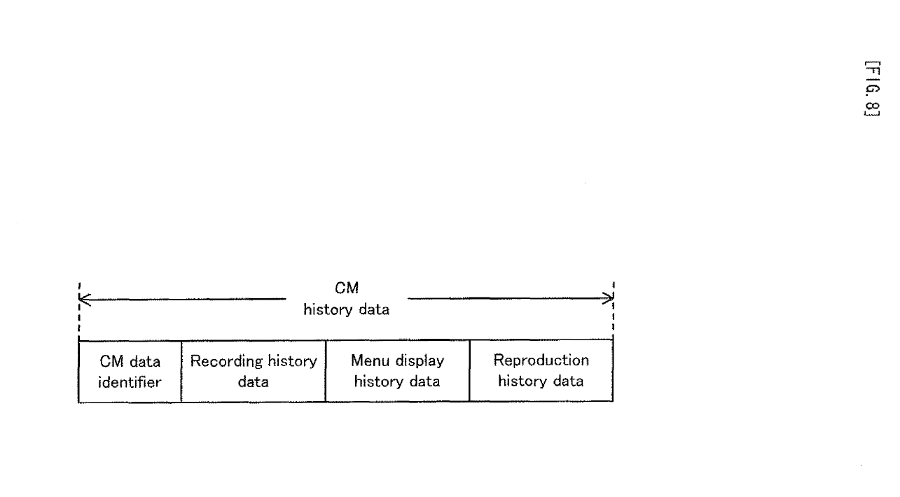

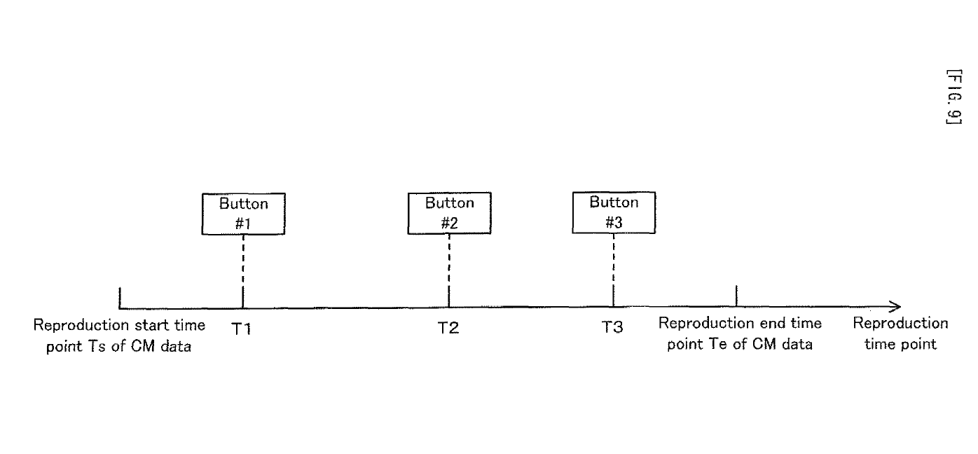

Here, with reference to FIG. 8 and FIG. 9, the details of the CM history data will be explained. FIG. 8 is a data structure diagram conceptually showing the data structure of the CM history data. FIG. 9 is a timing chart showing a concept when one example of a reproduction history is generated.

As shown in FIG. 8, the CM history data includes the CM data identifier; the recording history data, which indicates the number of times of recording the CM data specified by the CM data identifier onto the hard disk 109 or the like; the display history data, which indicates the number of times of menu-displaying the CM data specified by the CM data identifier or the like; and the reproduction history data, which indicates the number of times of reproducing the CM data specified by the CM data identifier and which indicates how long (more specifically, until which reproduction time point) the CM data specified by the CM data identifier is reproduced or the like.

Here, in order to generate the reproduction history data which indicates how long the CM data is reproduced, the CM data preferably has such a data structure as a menu button in the DVD-Video format.

More specifically, for example, as shown in FIG. 9, the CM data preferably has such a data structure that a button #1 is displayed at a predetermined reproduction time point T1, that a button #2 is displayed at a reproduction time point T2, and that a button #3 is displayed at a reproduction time point T3, wherein the reproduction time points T1 to T3 are between a reproduction start time point Ts to a reproduction end time point Te of the CM data. The button #1 displayed at the reproduction time point T1 preferably has such a control structure that does not allow the reproduction of the CM data to proceed after the reproduction time point T1 if the button #1 is not selected nor activated by the user. The button #2 displayed at the reproduction time point T2 preferably has such a data structure that does not allow the reproduction of the CM data to proceed after the reproduction time point T2 if the button #2 is not selected nor activated by the user. The button #3 displayed at the reproduction time point T2 preferably has such a data structure that does not allow the reproduction of the CM data to proceed after the reproduction time point T3 if the button #3 is not selected nor activated by the user.

Thus, if the user selects and activates all the buttons #1 to #3, the reproduction history data is generated which indicates the CM data is reproduced throughout from the reproduction start time point Ts to the reproduction end time point Te. If the user selects and activates the buttons #1 and #2, the reproduction history data is generated which indicates the CM data is reproduced from the reproduction start time point Ts to the reproduction time point T3. If the user selects and activates the button #1, the reproduction history data is generated which indicates the CM data is reproduced from the reproduction start time point Ts to the reproduction time point T2. If the user selects and activates none of the buttons #1 to #3, the reproduction history data is generated which indicates the CM data is reproduced from the reproduction start time point Ts to the reproduction time point T1.

However, not only the CM data having the data structure shown in FIG. 9 but also any CM data having such a data structure that the aforementioned button is displayed at an arbitrary time point between the reproduction start time point Ts and the reproduction end time point Te of the CM data allow the generation of the reproduction history data which indicates how much the CM data is reproduced.

### (2-2) Operation Example of CM History Collecting Server

Next, with reference to FIG. 10, an explanation will be given on an operation example of the CM history collecting server 200 in the information recording/reproducing system 100 in the example. FIG. 10 is a flowchart conceptually showing a flow of operations of the CM history collecting server 200 in the information recording/reproducing system 100 in the example.

As shown in FIG. 10, firstly, the CM history data transmitted by the hard disk recorder 100 is received (step S201).

Then, by the operation of the CM history analysis device 212a, the CM history analysis data, which is a result of analyzing the CM history, is generated on the basis of the CM history data received in the step S210 (step S202).

For example, the CM history analysis data may be generated by converting the CM history data into scores. Specifically, it is assumed that the number of times of recording the CM data onto the hard disk 109 is L, that the number of times of menu-displaying the CM data is M, that the number of times of reproducing the CM data is N, that the number of times that the button #1 shown in FIG. 9 is selected and activated is A, that the number of times that the button #2 shown in FIG. 9 is selected and activated is B, and that the number of times that the button #3 shown in FIG. 9 is selected and activated is C. In this case, the score expressed by 100L+10M+100N+100A+500B+1000C may be regarded as the CM history analysis data with respect to the CM data. Of course, the CM history analysis data may be generated in another aspect. In short, the CM history analysis data only needs to denote the degree of interest of the user in the CM data.

Then, under the control of the CPU 212, a predetermined incentive is given to the user who transmitted the CM history data (step S203). As the predetermined incentive, for example, the transmission of the CM history data may be regarded as an entry to a prize. In this case, it may be regarded as, for example, an entry to a prize for winning the product that is considered to have the high degree of interest of the user from the aforementioned score (i.e. the CM history analysis data). Alternatively, points may be given to the transmission of the CM history data. Incidentally, the user may be presented in advance with the indication that the incentive is given to the user by the transmission of the CM history data, by the transmission prompting data shown in FIG. 9.

As explained above, according to the information recording/reproducing system 1 in the example, users can watch the program data if selecting the program data menu-displayed on the menu screen. Meanwhile, the users can watch the CM data if selecting the CM data displayed on the same menu screen. That is, the users can selectively watch the CM data if the users want to watch the CM data. On the other hand, the users can selectively watch the program data without watching the CM data if the users do not want to watch the CM data. As described above, according to the example, of the program data and the CM data, the users can select and watch the desired data on their own. This can preferably prevent such a disadvantage that the CM data is not displayed or that the CM data is not displayed despite the users' intentions. As a result, it is possible to allow the users to certainly watch the sub data that the users desire.

Moreover, the program data and the CM data are menu-displayed on the same menu screen. Thus, the CM data can receive the benefit that the CM data easily catches users' eyes together with the program data. As a result, users can select and watch even the CM data in the same aspect as the program data.

In addition, since the history of the recording, menu-displaying, and reproduction of the CM data by users can be collected and analyzed, it is possible to certainly judge whether or not there is the effect of the CM data. At the same time, it is possible to generate the CM data which is more effective or which attracts users' interests, using the analysis result. Moreover, users can enjoy the benefit of obtaining the incentive by transmitting the history of the recording, menu-displaying, and reproduction of the CM data by the users.

Incidentally, in the aforementioned example, the hard disk is explained as one example of the information recording medium, and the recorder and the player related to the hard disk are explained as one example of the information recording/reproducing apparatus. The present invention, however, is not limited to the hard disk and the recorder and player thereof and can be applied to other various information recording media which support high-density recording or a high transfer rate, and recorders and players thereof.

The present invention is not limited to the aforementioned example, but various changes may be made, if desired, without departing from the essence or spirit of the invention which can be read from the claims and the entire specification. An information recording/reproducing apparatus and method, an information recording/reproducing system, and a computer program, all of which involve such changes, are also intended to be within the technical scope of the present invention.

1. An information recording/reproducing apparatus comprising:
a recording device for recording content data and sub data, which is transmitted in parallel with the content data, onto an information recording medium;
a first displaying device for displaying a menu screen which displays a list of at least one portion of the content data recorded by said recording device; and
a second displaying device for displaying a list of at least one portion of the sub data recorded by said recording device, on the menu screen together with the list of at least one portion of the content data,
wherein said second displaying device displays, on the menu screen, the list of at least one portion of the sub data related to the at least one portion of the content data displayed on the menu screen.

2. The information recording/reproducing apparatus according to claim 1, wherein said second displaying device displays the list of at least one portion of the sub data on the menu screen in substantially a same aspect as the list of at least one portion of the content data.

3. (canceled)

4. The information recording/reproducing apparatus according to claim 1, wherein said recording device records related data, which indicates a relation between the content data and the sub data transmitted in parallel with the content data, onto the information recording medium.

5. The information recording/reproducing apparatus according to claim 1, wherein
the sub data includes banner data which indicates one or a plurality of banner images used when the list of the sub data is displayed on the menu screen, and
said second displaying device displays the list of at least one portion of the sub data by displaying the desired banner image of the one or the plurality of banner images.

6. The information recording/reproducing apparatus according to claim 5, wherein said displaying device selects the desired banner image of the one or the plurality of banner images in accordance with at least one of resolution of the content data whose list is displayed on the menu screen, a position at which the banner image is displayed, and a display aspect of the menu screen, and said displaying device displays the list of at least one portion of the sub data by displaying the selected desired banner image.

7. The information recording/reproducing apparatus according to claim 1, wherein the sub data includes advertisement data related to the content data transmitted in parallel with the sub data.

8. The information recording/reproducing apparatus according to claim 1, wherein the information recording medium comprises a recording area in which the content data is recorded, and a recording area in which the sub data is recorded.

9. The information recording/reproducing apparatus according to claim 1, wherein the information recording medium has the sub data recorded in advance.

10. The information recording/reproducing apparatus according to claim 1, further comprising a generating device for generating history information which includes at least one of a recording history in which the sub data is recorded, a display history in which the list of at least one portion of the sub data is displayed, and a reproduction history in which the at least one portion of the sub data is reproduced.

11. The information recording/reproducing apparatus according to claim 10, wherein said generating device generates the history information which includes the reproduction history including a history which indicates how long the at least one portion of the sub data is reproduced.

12. The information recording/reproducing apparatus according to claim 10, further comprising a transmitting device for transmitting the history information generated by said generating device, to a collecting server for collecting the history information.

13. The information recording/reproducing apparatus according to claim 12, wherein prompting data which indicates a display screen for prompting a user to transmit the history information to said collecting server is recorded onto the information recording medium.

14. The information recording/reproducing apparatus according to claim 13, wherein said second displaying device displays a list of the prompting data on the menu screen, in preference to the list of at least one portion of the sub data recorded by said recording device.

15. An information recording/reproducing method comprising:
a recording process of recording content data and sub data, which is transmitted in parallel with the content data, onto an information recording medium;
a first displaying process of displaying a menu screen which displays a list of at least one portion of the content data recorded in said recording process; and
a second displaying process of displaying a list of at least one portion of the sub data recorded in said recording process, on the menu screen together with the list of at least one portion of the content data,
wherein said second displaying process displays, on the menu screen, the list of at least one portion of the sub data related to the at least one portion of the content data displayed on the menu screen.

16. An information recording/reproducing apparatus comprising:
an information recording/reproducing apparatus; and
a collecting server,
said information recording/reproducing apparatus comprising:
(i) a recording device for recording content data and sub data, which is transmitted in parallel with the content data, onto an information recording medium;
(ii) a first displaying device for displaying a menu screen which displays a list of at least one portion of the content data recorded by said recording device;
(iii) a second displaying device for displaying a list of at least one portion of the sub data recorded by said recording device, on the menu screen together with the list of at least one portion of the content data;
(iv) a generating device for generating history information which includes at least one of a recording history in which the sub data is recorded, a display history in which the list of at least one portion of the sub data is displayed, and a reproduction history in which the at least one portion of the sub data is reproduced; and
(v) a transmitting device for transmitting the history information generated by said generating device,
said collecting server comprising:
(i) an obtaining device for obtaining the history information transmitted by said transmitting device; and
(ii) an analyzing device for analyzing the history information obtained by said obtaining device,
wherein said second displaying device displays, on the menu screen, the list of at least one portion of the sub data related to the at least one portion of the content data displayed on the menu screen.

17. A computer readable recording medium recording thereon a computer program for recording/reproduction control and for controlling a computer provided in an information recording/reproducing apparatus comprising: a recording device for recording content data and sub data, which is transmitted in parallel with the content data, onto an information recording medium; a first displaying device for displaying a menu screen which displays a list of at least one portion of the content data recorded by said recording device; and a second displaying device for displaying a list of at least one portion of the sub data recorded by said recording device, on the menu screen together with the list of at least one portion of the content data, wherein said second displaying device displays, on the menu screen, the list of at least one portion of the sub data related to the at least one portion of the content data displayed on the menu screen,
said computer program making the computer function as at least one portion of said recording device, said first displaying device, and said second displaying device.
